(19) United States
(12) Patent Application Publication
(10) Pub. No.: US 2010/0265345 A1
(43) Pub. Date: Oct. 21, 2010

(54) VEHICLE BASED NIGHT-VISION ARRANGEMENT AND METHOD FOR OPERATING THE SAME

(75) Inventor: Lars Andersson, Vallda (SE)

Correspondence Address: WRB-IP LLP, 801 N. Pitt Street, Suite 123, ALEXANDRIA, VA, 22314, US

(73) Assignee: Volvo Lastvagnar AB, Goteborg (SE)

(21) Appl. No.: 12/741,415

(22) PCT Filed: Nov. 5, 2007
(86) PCT No.: PCT/SE07/00980

§ 371 Date: May 7, 2010

(51) Int. Cl. H04N 5/225

(52) U.S. Cl. 348/216.1; 348/E05.024

(57) ABSTRACT

A vehicle based night-vision arrangement includes a night-vision camera, an analyzer unit for analyzing image information collected by the night-vision camera and extracting a kind and/or position of a probable obstacle ahead in a driving direction of the vehicle; and a control unit to initiate producing a light spot on the display unit indicating the probable obstacle. A method for operating such a vehicle based night-vision arrangement is also provided.

### BACKGROUND AND SUMMARY

The invention relates to a vehicle based night-vision arrangement and a method for operating the same.

Vehicle based night-vision systems are used to increase traffic safety when the vision of a driver is diminished by ambient influences such as a lack of daylight. It is known in the art to use infrared night-vision systems for detecting obstacles at a much earlier stage than is possible by using the natural sight of the driver. Images of the infrared image of the environment ahead of the vehicle can be displayed either on a separate screen or a full image picture is projected onto the windscreen of the vehicle. As driving in the night is often perceived by the driver to be more tiresome than driving in daylight, several solutions have been proposed for providing more comfort and reliability of such night-vision systems.

A night-vision camera system with a head-up display mounted on the windscreen is disclosed in U.S. 2006/0043295 A1, which allows an easy visual check by the driver while looking in the normal forward direction. The image displayed on the screen of the head-up display is changed between an environmental area close to the vehicle to a distant environment area when it is detected that the headlights have been switched to the high beam setting to allow the driver to check the image of the field far ahead of the vehicle which is accessible when using the high beam setting.

Another night-vision system with a head-up display is disclosed in U.S. Pat. No. 7,092,007 B2. The system decreases the luminance of the screen when the vehicle is driving with a low speed where the night-vision support is assumed not to be necessary. Decreasing the luminance of the screen avoids distraction of the driver by the image displayed on the screen.

It is desirable to provide a vehicle based night-vision arrangement and an operating method for the same which allows to informing the driver of probable obstacles ahead of the vehicle without distracting the driver in an unduly manner.

A vehicle based night-vision arrangement is proposed which comprises a night-vision camera; an analyzer unit for analyzing image information collected by the night-vision camera and extracting a kind and/or position of a probable obstacle ahead in driving direction of the vehicle; and a control unit to initiate producing a light spot on the display unit indicating the probable obstacle, particularly indicating the location of the probable obstacle. By analyzing the image and extracting essential information out of the image it is possible to display only the essential information such as an obstacle to the driver instead of providing a full image. The obstacle can be, for example, a pedestrian, an animal, a vehicle which could be overlooked by the driver in the darkness or be recognized late because of lack of vision in the darkness. By reducing the information content of the displayed image, the driver is less distracted and receives only essential information without unwanted additional and less essential image information. The task of analyzing the displayed image is moved from the driver to the night-vision arrangement thus relieving the driver from distracting work during driving. Favourably, the driver experiences less demands on the driver's attention when observing the display unit. Driving in the darkness becomes less tiresome because it is not necessary for the driver to observe a complete image produced on the display unit by the night vision camera additionally to the real image of the environment accessible through the vehicle's windscreen. The display unit can be a windscreen, a rear screen and/or a rearward looking rearview mirror as well as a separate screen well placed in the field of view of the driver. Advantageously, the light spot can be placed on the display unit, e.g. the windscreen, mirror or the like, at the very position which corresponds to the location of the obstacle if the vision conditions would allow the driver to realize the obstacle in reality.

Preferably, a light source is provided which is controlled by the control unit to direct a light beam of the light source the display unit for representing the obstacle on the display unit. It is possible, however, that the display unit indicates the light spot not by being irradiated with a light beam but by switching on a light source in the display unit at the proper location on the screen corresponding to the location of the obstacle.

In a preferred embodiment, a selection unit can be provided for selecting the display unit depending on a driving direction of the vehicle. Preferably, the selection unit can trigger switching the light spot between a windscreen and at least one of a rear screen, a rearview interior mirror, exterior mirror. When driving in a forward direction the selection unit directs the light beam to a windscreen of the vehicle. The light spot on the windscreen is easily recognizable for the driver. When driving in a rearward direction, e.g. when manoeuvring the vehicle, the light spot can be directed to a rearview mirror, e.g. the interior rearview mirror or exterior rearview mirror or both in which the driver is assumed to look when driving rearwards, and/on the rear screen. The light spot can be reliably placed in the field of vision of the driver thus avoiding to force the driver to direct the view off the line of sight which is normal for driving forward or rearward.

Preferably, the light source can comprise a laser source. This allows producing a clearly visible and well defined light spot on the display unit. Advantageously, the light spot is placed on the display unit, e.g. the windscreen, at the very position which corresponds to the location of the obstacle if the vision conditions would allow e.g. normal daylight sight.

According to a further embodiment an assigning unit can be provided for assigning an icon to the obstacle in order to display the obstacle as an icon indicating the kind of obstacle. The driver can intuitively comprehend which kind of situation has to be handled, e.g. if the obstacle is moving and may cross the lane before the vehicle of if the obstacle is immotile at the lane border. The icon can also be a section of the image taken by the night-vision camera showing a real image of the obstacle.

In a preferred embodiment a decision unit can be provided for deciding if there is a potential collision risk between the obstacle and the vehicle. Thus it is possible to alert the driver only in situations where a risk is detected, and the driver can immediately know where the danger is located by the light spot on the display unit, e.g. particularly on the windscreen or the rear screen, depending on the driving direction of the vehicle.

According to an advantageous embodiment, the night-vision arrangement can provide a link to a driver-head position detection system. Thus, the night-vision arrangement can be coupled to the head position detection system. The position of the light spot can advantageously be adjusted according to the detected position of the driver's head.

A method for operating a vehicle based night-vision arrangement is proposed with the steps of producing an image of an environment ahead in the driving direction of a vehicle; analyzing the image information; extracting information representing a probable obstacle for the vehicle; triggering a control unit to initiate producing a light spot representing the obstacle on the display unit. The driver can receive essential information without being overburdened by excessive information. The driver is released from analyzing the complete image and receives only necessary information thus saving time for adequate reaction to the situation.

Preferably, the control unit can direct a light beam of a light source to the display unit corresponding to the location and/or kind of the obstacle. The driver can observe the obstacle on the display unit as light spot.

In a preferred step, assigning a location on the display unit representing the location of the obstacle with respect to the vehicle can be performed. The driver can intuitively perceive where the obstacle has to be assumed and react accordingly.

By selecting the display unit depending on the driving direction of the vehicle, the driver can reliably be informed about probably critical situations when driving forward as well as rearward. Preferably, the light beam can be directed to a windscreen when driving forward, and when driving rearward at least to one of a rear screen, a rearview interior mirror, a rearview exterior mirror. The driver can be made aware of an obstacle by bringing the light spot into the adequate field of vision of the driver.

By selecting an icon representing the kind of the obstacle and representing the icon as light spot on the display unit, the driver can be supported to easily identify the obstacle and can thus adapt the driving behaviour accordingly.

By preferably triggering the display of the light spot only in a potentially critical situation, irritation of the driver and distracting of the driver from driving the vehicle can be avoided. Driving under night-vision circumstances becomes less tiresome.

### BRIEF DESCRIPTION OF THE DRAWINGS

The present invention may best be understood from the following detailed description of the embodiments, but not restricted to the embodiments, wherein is shown schematically:

FIG. 1 a schematic representation of a preferred night-vision arrangement displaying a representation of an obstacle in a windscreen of a vehicle;

FIG. 2 a schematic sketch of preferred display units on a vehicle; and

FIG. 3 a view through a windscreen with an obstacle displayed on the windscreen.

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

### DETAILED DESCRIPTION

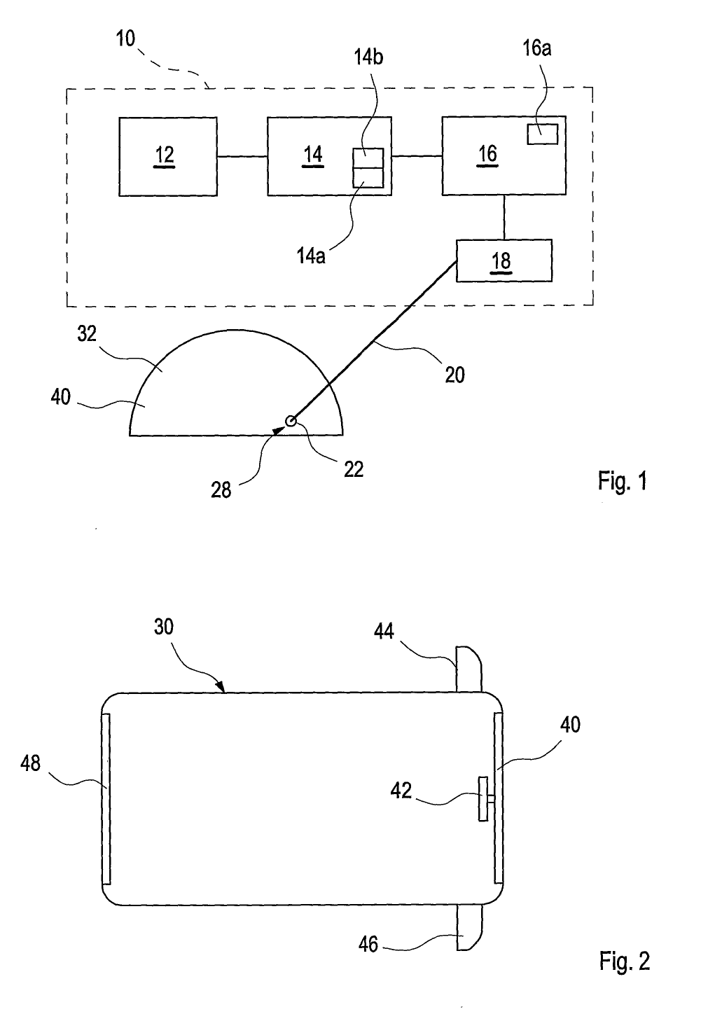

For explaining the invention, a preferred embodiment of a vehicle based night-vision arrangement 10 is depicted in FIG. 1. The night-vision arrangement 10 comprises a night-vision camera 12 which records images of the environment ahead of a vehicle (not shown) preferably in the vehicles driving direction. The night-vision camera 12 is preferably an infrared camera with a digital image sensor. It is possible that the arrangement 10 provides a night-vision camera 12 looking forward and rearview. An analyzer unit 14 receives image data from the night-vision camera 12 and analyzes the image information collected by the night-vision camera 12. The analyzer unit 14 is preferably embodied as a picture analyzer and sorts out relevant information contained in the picture. This can be done by means of pattern recognition or other methods known in the art. For instance contours of objects in the image can be identified and compared to data e.g. in a database. Additionally, digital map data can be included for distinguishing road contours, terrain characteristics and the like from probable obstacles in the route of the vehicle. Such obstacles can be such as human beings, animals, other vehicles parking at the roadside. When driving through a forest area an encounter on the road with animals as obstacles can be larger than the encounter with human beings. Thus the speed of identification of an obstacle can be increased when taking into account the kind of area through which the vehicle is moving.

If the visibility is bad and the driver relies only on the own vision as usually is the case during night time, such obstacles can probably be recognized only in shorter distances which are less adequate for an in-time reaction of the driver thus causing a probable risk of a collision. The night-vision camera 12 provides a much better range of vision than the natural vision of the driver. By extracting the relevant information from the image taken by the night-vision camera 12 in form of probable obstacles, less relevant information can be ignored. If an obstacle is detected, a position of the obstacle as well as the kind of obstacle, e.g. mobile obstacle such as a human being, an animal, or an immobile obstacle such as a parking car, can be determined. The data of the analyzing unit 14 are provided to a control unit 16 for directing a light beam 20 of a light source 18 to a display unit 32.

The light beam 20 produces a light spot 22 on the display unit 32, e.g. a windscreen, indicating the presence of the probable obstacle. Preferably, the location of the light spot 22 on the display unit 32 corresponds to the location of the obstacle on the road. Thus, the light spot 22 on the display unit 32, e.g. a windscreen 40, is placed geometrically in the way that if the vision conditions were better, the driver would see the obstacle at the very location on the display unit 32 where the light spot 22 is displayed. The driver then intuitively knows where the obstacle is.

Preferably, if the vehicle is equipped not only with a forward looking night-vision camera 12 but also with a rearward looking night-vision camera, a selection unit 16a for selecting an appropriate display unit 32 depending on a driving direction of the vehicle can be coupled to the control unit 16. Particularly, the selection unit 16a provides switching of the light spot 22 between a windscreen 40 and at least one of a rear screen 48, a rearview interior mirror 42, a rearview exterior mirror 44, 46, as indicated in FIG. 2.

Preferably, a decision unit 14a can be coupled to the analyzer unit 14 for deciding if the obstacle represents a potential collision risk for the vehicle. If yes, the light beam 20 can be directed to the appropriate display unit 32. Preferably, the light source 18 is a laser source, particularly a laser beamer. An assigning unit 14b can be coupled to the analyzer unit 14 for assigning an icon to the obstacle in order to display the obstacle as an icon indicating the kind of obstacle. The driver receives comprehensive information which kind of obstacle is present.

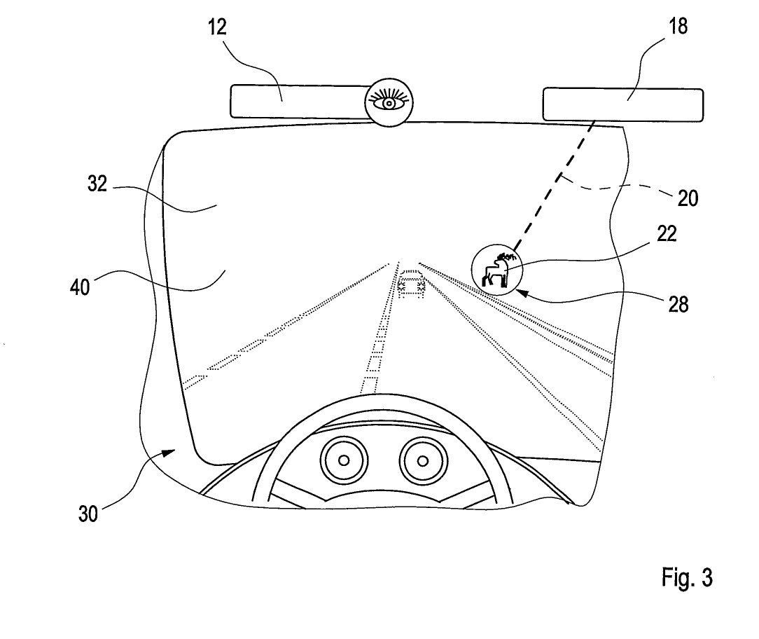

Referring now to FIG. 3, a sketch of a preferred embodiment of the invention is depicted. When driving a vehicle 30 along a road during night time the driver has reduced vision. Particularly the lane borders are hardly to be seen and vanish in the darkness. Only areas which are illuminated by the headlights of the vehicle or areas which are illuminated by external light sources can be seen and reveal visual information. Thus, a night-vision camera 12 takes images in infrared light which increase the contrast of objects compared to the weak contrast of objects seen in light in the visual wavelength spectrum during night time.

A windscreen 40 is preferably used as display unit 32 for displaying information provided by the night-vision camera 12. By way of example in the embodiment depicted in FIG. 3 the forward looking night-vision camera 12 is mounted as a head-up unit at the top of the windscreen 40 looking ahead of the vehicle 30. The wind screen is in the field of vision of the driver when the driver is sitting on the driver's seat. Alternative positions of the night vision system can be chosen if necessary or more appropriate.

The night-vision camera 12 produces an image of the environment ahead in the driving direction of a vehicle 30 which is analyzed by the analyzing unit 14 of the night-vision arrangement 10 (FIG. 1). Image information of objects which can represent a probable obstacle 28 can be extracted by the analyzing unit 14 (FIG. 1). A control unit 16 (FIG. 1) triggers a light source 18 to direct a light beam 20 to the windscreen 40 which is chosen as display unit 32.

The light beam 20 produces a light spot 22 at the very location on the windscreen 40 where the driver would see the obstacle 28 if the driver were able to see the obstacle 28, the light spot 22 representing the obstacle 28 on the display unit 32. The obstacle 28 is represented by an icon, e.g. depicting a deer, thus alerting the driver that such an animal might cross the road and may be attracted and immobilized by headlights of a vehicle 30. During driving along the road, the driver automatically realizes the light spot 22, i.e. the icon indicating that an obstacle 28 is ahead in the route of the vehicle as the light spot 22 is in the field of vision of the driver when looking through the windscreen. The driver is not distracted by a complicated image on the display unit 32 but receives the essential information about the presence of the obstacle. As the location of the light spot 22 on the windscreen 40 is chosen so that the driver would see the obstacle 28 at that very location through the windscreen 40 if the driver would seen the obstacle 28, the driver intuitively receives information about the distance of the obstacle 28 from the vehicle 30.

The driver can easily gather the information and react accordingly, e.g. slowing down or be prepared to break and the like. The proposed arrangement and method increases traffic safety and driving for the driver during night-time traffic.

1. A vehicle based night-vision arrangement, including
a night-vision camera
an analyzer unit for analyzing image information collected by the night-vision camera and extracting a kind and/or position of a probable obstacle located ahead in driving direction of the vehicle,
a control unit for producing a light spot on the display unit indicating the probable obstacle, and
a selection unit for selecting the display unit depending on a driving direction of the vehicle.

2. The arrangement according to claim 1, comprising a light source directing a light beam of the light source the display unit corresponding to the location and/or kind of the obstacle.

3. The arrangement according to claim 1, wherein the selection unit is arranged to switch the light spot between a windscreen and at least one of a rear screen, a rearview interior mirror, a rearview exterior mirror.

4. The arrangement according to claim 1, wherein the light source comprises a laser source.

5. The arrangement according to claim 1, comprising an assigning unit for assigning an icon to the obstacle in order to display the obstacle as an icon indicating the kind of obstacle.

6. The arrangement according to claim 1, comprising a decision unit for deciding if the obstacle represents a potential risk for the vehicle.

7. The arrangement according to claim 1, comprising a link to a driver head position detection system.

8. A method for operating a vehicle based night-vision arrangement according to one of the preceding claims, including
producing an image of an environment ahead in the driving direction of a vehicle,
analyzing the image information,
extracting information representing a probable obstacle for the vehicle,
triggering a control unit to initiate producing a light spot representing the obstacle on the display unit, and
selecting the display unit depending on the driving direction of the vehicle.

9. The method according to claim 8, comprising selecting the location in the display unit corresponding to a location where the obstacle would appear if perceived by natural vision of the driver.

10. The method according to claim 8, comprising assigning a location on the display unit representing the location of the obstacle with respect to the vehicle.

11. The method according to claim 8, characterized by directing a light beam to the display unit for producing the light spot.

12. The method according to claim 8, comprising directing the light beam to a windscreen or at least one of a rear screen, a rearview interior mirror, a rear view exterior mirror.

13. The method according to claim 8, comprising selecting an icon representing the kind of the obstacle and representing the icon as light spot on the display unit.

14. The method according to claim 8, comprising triggering the display of the tight spot only in a potentially critical situation.

15. The method according to claim 8, comprising adjusting the position of the light spot according to a driver head position detected with a driver head position system.
